(19) United States
(12) Patent Application Publication
(10) Pub. No.: US 2025/0094135 A1
(43) Pub. Date: Mar. 20, 2025

(54) METHOD AND APPARATUS FOR MODIFYING DATA OF SOFTWARE OBJECT, DEVICE AND MEDIUM

(71) Applicant: Lemon Inc., Grand Cayman (KY)

(72) Inventor: Yang YU, Beijing (CN)

(21) Appl. No.: 18/886,648

(22) Filed: Sep. 16, 2024

(30) Foreign Application Priority Data
Sep. 15, 2023 (CN) 202311198771.1

(51) Int. Cl. G06F 8/33

(52) U.S. Cl. CPC G06F 8/33

(57) ABSTRACT

Embodiments of the present disclosure provides a method and apparatus for modifying data of a software object, a device and a medium. In a specific implementation, the method includes: receiving a target instruction for modifying a target object, and parsing the target instruction to determine therefrom at least an operation type of the target instruction and an access path from the target object to target data included in the target object; and searching the target data from the target object according to the access path, and if the search is successful, modifying the target data at least according to the operation type. Through the method, the data included in the software object can be modified efficiently, thereby, the running performance of a software application can be improved.

### CROSS-REFERENCE TO RELATED APPLICATIONS

This application claims the priority to and benefits of the Chinese Patent Application, No. 202311198771.1, which was filed on Sep. 15, 2023. The aforementioned patent application is hereby incorporated by reference in their entireties.

### TECHNICAL FIELD

Embodiments of the present disclosure relates to the technical field of computer technology, and in particular to a method and apparatus for modifying data of a software object, a device and a medium.

### BACKGROUND

In the running of some software applications, it is hoped that software objects can be dynamically modified. For example, a client application acquires predicted data in advance and loads an object according to the predicted data, and then acquires updated data of the predicted data based on real data, thus it is hopes that a loaded object of the client can be modified according to the updated data. However, in some scenarios, there is a lack of efficient dynamic modification methods for software objects in the related art.

Therefore, a new method for modifying data of a software object is needed.

### SUMMARY

Embodiments of the present disclosure provide a method and apparatus for modifying data of a software object, a device and a medium.

In a first aspect, the present disclosure provides a method for modifying data of a software object, which includes:

receiving a target instruction for modifying a target object, and parsing the target instruction to determine therefrom at least an operation type of the target instruction and an access path from the target object to target data included in the target object; and

searching the target data from the target object according to the access path, and if the search is successful, modifying the target data at least according to the operation type.

In a second aspect, the present disclosure provides an apparatus for modifying data of a software object, which includes:

a parsing unit configured to receive a target instruction for modifying a target object, and parse the target instruction to determine therefrom at least an operation type of the target instruction and an access path from the target object to target data included in the target object; and

a modifying unit configured to search the target data from the target object according to the access path, and if the search is successful, modify the target data at least according to the operation type.

In a third aspect, the present disclosure provides a computer-readable storage medium having a computer program stored thereon, wherein the computer program, when executed in a computer, causes the computer to perform the method according to the first aspect.

In a fourth aspect, the present disclosure provides an electronic device, which includes a memory and a processor, wherein executable codes are stored in the memory, and the executable codes, when executed by the processor, cause the processor to implement the method according to the first aspect.

Embodiments of the present disclosure provides a method and apparatus for modifying data of a software object, a device and a medium. A target instruction for modifying a target object can be received, and the target instruction is parsed to determine therefrom at least an operation type of the target instruction and an access path from the target object to target data included in the target object. Then, the target data is searched from the target object according to the access path, and if the search is successful, the target data is modified at least according to the operation type. With any of the method, the apparatus, the storage medium and the electronic device mentioned above, the data included in the software object can be modified efficiently, thereby, the running performance of a software application can be improved.

### BRIEF DESCRIPTION OF DRAWINGS

FIG. 1 shows a schematic diagram of an object structure;

FIG. 2 shows a flow diagram of a method for modifying data of a software object according to embodiments of the present disclosure;

FIG. 3 shows a schematic diagram of a target instruction according to embodiments of the present disclosure;

FIG. 4 shows a schematic diagram of an access path of target data according to embodiments of the present disclosure;

FIG. 5 shows a schematic diagram of an operation class according to embodiments of the present disclosure;

FIG. 6 shows a schematic diagram of a nest instruction according to embodiments of the present disclosure;

FIG. 7 shows a schematic diagram of acquiring target data by reflection according to embodiments of the present disclosure;

FIG. 8 shows a schematic block diagram of an apparatus for modifying data of a software object according to embodiments of the present disclosure;

FIG. 9 shows a structural schematic diagram of an electronic device suitable for implementing embodiments of the present disclosure; and

FIG. 10 shows a structural schematic diagram of a storage medium suitable for implementing embodiments of the present disclosure.

### DETAILED DESCRIPTION

A further detailed description of the technical solution provided by the present disclosure will be provided in combination with the accompanying drawings and embodiments. It can be understood that the specific embodiments described herein are only used to explain the relevant invention, and not to limit the invention. Additionally, it should be noted that for ease of description, only the parts related to the invention are shown in the accompanying drawings. It should be noted that, without conflict, the embodiments disclosed herein and the features in the embodiments can be combined with each other.

In the description of the implementation of this disclosure, the term “including” and similar terms should be understood as open-ended inclusion, that is, “including but not limited to”. The term “based on” should be understood as “based at least in part”. The term “one implementation” or “the implementation” should be understood as “at least one implementation”. The term “some implementations” should be understood as “at least some implementations”. The following text may also include other explicit and implicit definitions.

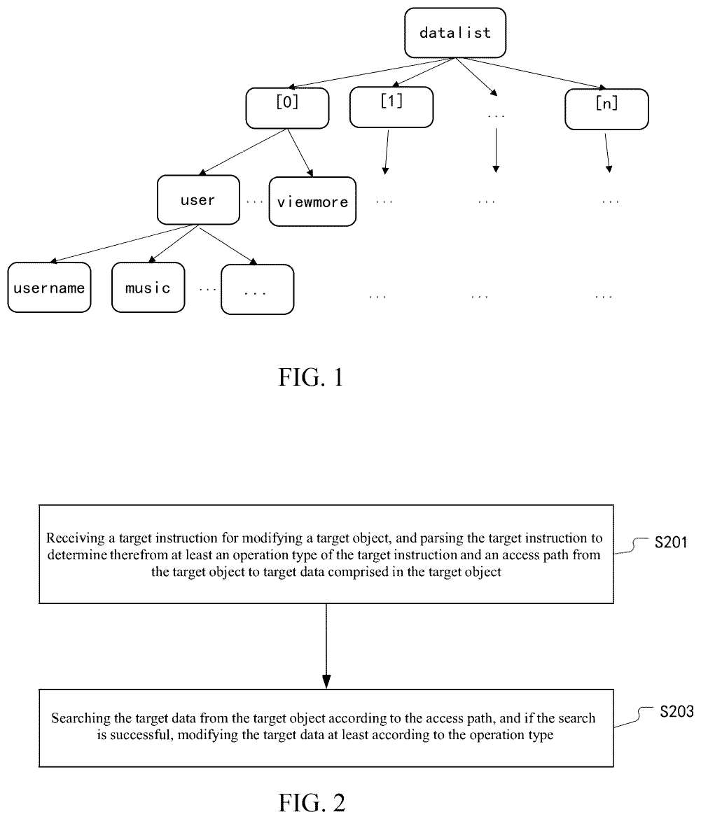

As mentioned above, in some software application scenarios, it is desired that software objects can be modified dynamically. For example, a client application first acquires predicted data and loads an object according to the predicted data, and then acquires updated data of the predicted data based on real data, thus it is hopes that the preloaded object is modified according to the updated data. However, in an actual running scenario, the modification of the existing object is often to modify part of the data of the object, and the existing object usually forms a tree-like structure inclusion relationship with data included in the object (for example, data of an object type or a basic type). In the related art, there is a lack of efficient methods for accurately modifying the part of the data included in the object. For example, FIG. 1 shows a schematic diagram of an object structure. As shown in FIG. 1, for example, the target object is a datalist object, and the datalist object is an array object, which includes multiple array members, such as datalist[0], datalist[1], . . . , datalist[n]. Each array is itself an object and may include its own attributes. For example, datalist[0] may include its attributes “user” and “viewmore”. The attribute “user” itself may also be an object, which may, for example, include its attribute “username”. For example, when the target data to be modified is the attribute “username”, there is a lack of efficient methods to accurately modify this attribute in the related art.

In order to solve the above technical problems, embodiments of the present disclosure provide a method for modifying data of a software object. In some embodiments, a target instruction for modifying a target object can be received, the target instruction can be parsed to determine therefrom, for example, an operation type of the target instruction, an access path from the target object to target data included in the target object, and a target value. Then, the target data is searched from the target object according to the parsed access path, and if the search is successful, the target data of the target object is modified at least according to the operation type of the target instruction and the target value. The method has the following advantages. On the one hand, the provided method can implement the dynamic modification of data in the object. Specifically, the access path of the data to be modified may be included in the target instruction, such that a receiver of the target instruction can acquire a location (access path) of the modified target object by parsing the target instruction, and then can accurately search the target data from the target object according to the access path and modify the target data. On the other hand, the target instruction may also include different operation types, such that a plurality of different operation types may be acquired by parsing the target instruction, and then different modification operations may be performed on the target data according to different operation types. In different embodiments, the operations for the target data may also be optimized according to the different data types of the target data, thus, a universal modification solution for object data of different data types covering different operation types can be provided. Thirdly, in some embodiments, when the target data is searched, the access path and the modified target data can be stored in a predetermined cache in an associated manner, such that the target data with the same access path can be directly extracted from the cache in a subsequent accessing, and the overall modification efficiency of the target data can be further improved.

A detailed process of the provided method is further described below.

FIG. 2 shows a flow diagram of a method for modifying data of a software object according to embodiments of the present disclosure. As shown in FIG. 2, the method at least includes the following steps:

step S201, receiving a target instruction for modifying a target object, and parsing the target instruction to determine therefrom at least an operation type of the target instruction and an access path from the target object to target data included in the target object; and

step S203, searching the target data from the target object according to the access path, and if the search is successful, modifying the target data at least according to the operation type.

First, in step S201, a target instruction for modifying a target object is received, and the target instruction is parsed to determine therefrom at least an operation type of the target instruction and an access path from the target object to target data included in the target object.

An object can usually be used as a basic unit of a program, and an object may contain data and functions that manipulate the data. In different embodiments, the target object may be different specific types of objects, which is not limited herein. In an embodiment, it may be, for example, a model object which can be used to save data, such that an interface can be rendered through the data saved by the model object, for example.

In this step, the receiver of the target instruction receives a modification instruction (target instruction) for the target object sent by an instruction sender. The target instruction is parsed to determine therefrom at least an operation type of the target instruction and an access path from the target object to target data included in the target object. In different embodiments, the specific receiver and sender of the target instruction may be different. In an embodiment, the receiver of the target instruction may be, for example, a client application on a user terminal, and the sender may be a server that determines the updated data. For example, the server may send a modification instruction for the target object to the client application after determining the updated data. In different embodiments, the user terminal may be different types of computer devices, which is not limited in this specification. In an embodiment, the user terminal may be, for example, a mobile terminal, which specifically may be one of a mobile phone, a notebook, a tablet computer and a vehicle-mounted computer.

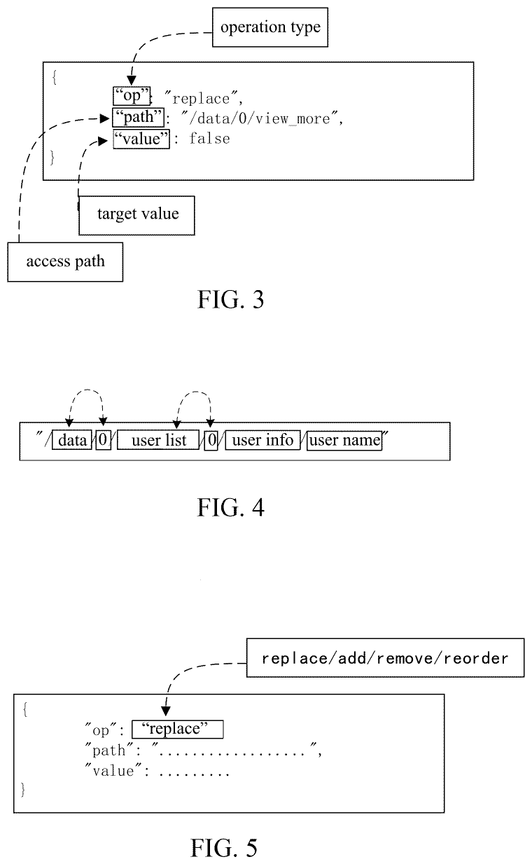

The target instruction may include the operation type for modifying and the access path of the target data. In an embodiment, according to the specific operation type, the target instruction may further include a modified target value. FIG. 3 shows a schematic diagram of a target instruction according to embodiments of the present disclosure. As shown in FIG. 3, the target instruction may include, for example, an operation type (“op”), an access path (“path”) of the target data and a target value (“value”).

The access path of the target data, that is, the access path from the target object to the target data included in the target object, can be used to determine a specific location of the target data in the target object. In different embodiments, access paths may be built in different ways. In an embodiment, the access path includes a plurality of fields in sequence, an initial field in the plurality of fields corresponds to the target object, a last field in the plurality of fields corresponds to the target data, and the remaining fields in the plurality of fields correspond to intermediate objects between the target object to the target data, the intermediate object includes a single object or an array object, where a post field of a corresponding field of any array object corresponds to an array member of the array object. In different embodiments, the fields shown may be split by predetermined symbols, for example. In different specific embodiments, the predetermined symbols may be different. In one specific embodiment, the predetermined symbols may be split by the symbol “/”, for example. FIG. 4 shows a schematic diagram of an access path of target data according to an embodiment of the present disclosure. In the example shown in FIG. 4, the access path of target data may be “/data/0/user_list/0/userinfo/username”, which includes several sequential fields split by “/”: “data”, “0”, “user_list”, “0”, “userinfo”, “username”. Where, “data” represents a target object, which may be, for example, a datalist object, datalist is one array object which may include different array members, and a combination of the “data” field and the following field “0” may represent a member object of the datalist object with subscript 0 and can be identified as datalist[0]. “user_list” may represent an attribute of the datalist[0] object, which itself may be a userlist object; and a combination of “user_list” field and the following “0” field may represent a member object of the userlist object with subscript 0 and can be represented as userlist[0]. The userlist[0] object also has an attribute “userinfo”, and the attribute “userinfo” is itself an object and also has an attribute “username”, which is a basic type (for example, one of a numeric type, Boolean type or string type). It thus can be seen that the access path can indicate a location of the target data in the target object.

In different embodiments, the target instruction may include different operation types. FIG. 5 shows a schematic diagram of an operation class according to embodiments of the present disclosure. As shown in FIG. 5, in an embodiment, the operation type may include a replace operation for changing a value of the target data. The target instruction may be parsed to determine therefrom the operation type of the target instruction, the access path from the target object to target data in the target object, and the target value. In another embodiment, the operation type may include an add operation for adding array members or attributes included in the target data, such that the target instruction may be parsed to determine therefrom the operation type of the target instruction, the access path from the target object to target data in the target object, and the target value. In yet another embodiment, the operation type may further include a reorder operation which is used for reordering the array members included in the target data. The target instruction may be parsed to determine therefrom the operation type of the target instruction, the access path from the target object to target data in the target object, and the target value. In yet another embodiment, the operation type may further include a remove operation for setting the value of the target data as a default value. Through the above method, a universal modification solution for object data of different data types covering different operation types can be provided.

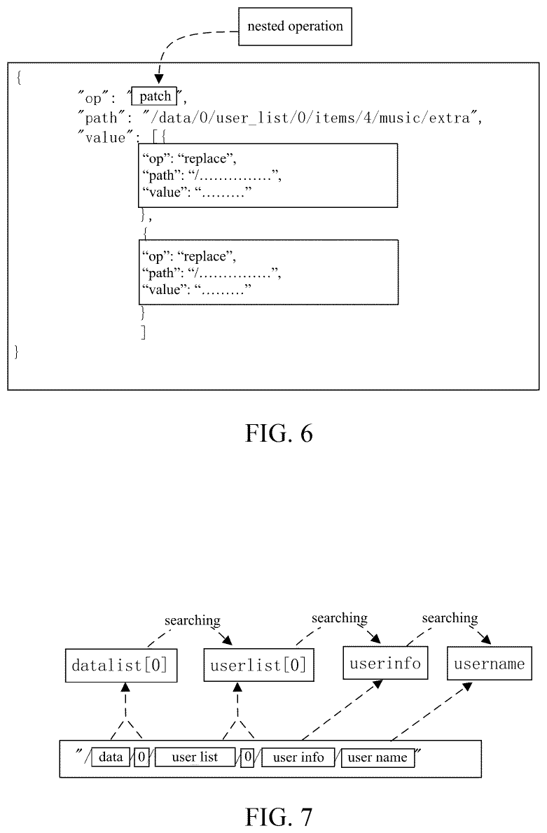

In an embodiment, the operation type may also include a nested operation. Specifically, if the operation type is the nested operation, the target value may include one or more sub-instructions, and the operation type of each sub-instruction may include one selected from the group of the add operation, the remove operation, the replace operation, the reorder operation and the nested operation. Each sub-instruction may be further parsed from the target value. FIG. 6 shows a schematic diagram of a nest instruction according to embodiments of the present disclosure. In an example shown in FIG. 6, the nested operation may include a plurality of sub-instructions. In this way, in the subsequent steps, various operations may be performed on, for example, specific types of target data according to various sub-instructions. In different specific embodiments, the specific type of the nested operation may be different. In a specific embodiment, in the subsequent steps, for example, various operations may be performed on the target data of Json object type according to the nested operation.

Then, in step S303, the target data is searched from the target object according to the access path, and if the search is successful, the target data is modified at least according to the operation type.

The target data can be searched from the target object by reflecting the attributes included in the target object layer by layer according to the access path. In an embodiment, the plurality of fields may be sequentially parsed from the access path, where for each field before the last field, if the field corresponds to a single object, the single object corresponding to the field is obtained by reflection, and an attribute corresponding to a post field of the field is searched from attributes included in the single object corresponding to the field; if the field corresponds to an array object, the array member corresponding to the post field of the field is obtained by reflection according to the field and a subscript of the post field of the field, and an attribute corresponding to the post field of the field is searched from attributes included in the array member. FIG. 7 shows a schematic diagram of acquiring target data by reflection according to an embodiment of the present disclosure. For example, the object datalist[0] can be obtained according to the reflection of fields “data” and “0”, “user_list” can be searched from attributes of the object datalist[0], then the object “userlist[0]” can be obtained according to the reflection of “user_list” and “0”, “user info” is searched from attributes of userlist[0], the object “user info” is obtained by reflection, and “username” is searched from attributes of the object “user info”. In an embodiment, after the target data is searched, the target data may be modified through a parent object of the target data. For example, in the example shown in FIG. 7, its attribute “username” may be modified through the above-mentioned object “user info”. In an embodiment, for example, in the sequential search by field as shown in FIG. 7, if any one of the attribute or array member searches by field fails, a search failure for the target data may be exited and a determination may be made that the search for the target data is not successful. In an embodiment, if it is determined that the search for the target data is not successful, the modification of the target data can be abandoned.

As mentioned above, in different embodiments, the operation type of the target instruction may be different. In an embodiment, if the operation type is the replace operation, a value of the target data may be changed according to the target value. In a specific embodiment, if a data type of the target data is a basic type, the data type of the target value may be converted into the basic type, and the value of the target data is changed according to the converted target value. In another embodiment, if the data type of the target data is an object type, deserializing may be performed according to the target value to obtain an instance of the object type, and the instance is endowed to the target data. In an embodiment, if the operation type is an add operation, an array member or attribute included in the target data is added according to the target value. In an embodiment, if the operation type is a remove operation, the value of the target data is set as a default value. In an embodiment, if the operation type is a reorder operation, the array members included in the target data are reordered according to the target value. In an embodiment, if the operation type is the nested operation, various operations may be performed on, for example, a specific type of target data according to various sub-instructions included in the target value. In this way, different operation types may be modified for object data of different data types.

In an embodiment, if the search is successful, the access path and the modified target data can be stored in a predetermined cache in an associated manner. In a specific embodiment, in order to prevent different object classes from having attributes with duplicate names, the confusion of attributes with duplicate names in the buffer can be prevented by taking the advantage of the fact that attributes with the same name cannot exist under the same object. Therefore, if the data type of the target data is an object, the access path, a parent object of the target data and the modified target data are stored in the cache in an associated manner. For the attributes of the basic types, the problem that different object classes have duplicate names does not exist. Therefore, in another specific embodiment, if the data type of the target data is the basic type, the access path, the modified target data, and the class name to which the target data belongs may be stored in the cache in an associated manner. In this way, a mapping relationship between the recently accessed access path (for modifying data access) and the target data can be saved in the cache, so that when the target data of the same access path is accessed again, the modification can be made according to the target data extracted from the cache, without searching for the target data by reflection layer by layer according to the access path again; and due to the fact that the recently accessed data has a high probability of being accessed again in a subsequent operation of the application, the time consumed for modifying the object data is greatly shortened.

In order to further improve the efficiency of modifying object data, in an embodiment, the target object may be a pre-built global singleton object. In an actual running environment of the application, a scenario for modifying data is often not a first scenario for loading the target object, but an existing solution for modifying the target object usually build the target object used in this scenario separately under the scenario for modifying data. For example, the scenario for modifying the object data in an application is, for example, a search scenario, and the scenario before the search scenario is, for example, a recommended content scenario, in which the target object used by the scenario is also built. Therefore, for example, the target object built by the recommended content scenario can be set as a global singleton object. The global singleton object means that this type of object has only one object instance in the global scope and can be accessed in the global scope. Furthermore, the global singleton object can be used in the scenario for modifying the object data, therefore, in the scenario of modifying object data, the time cost of building objects can be reduced, and the execution efficiency of applications can be improved.

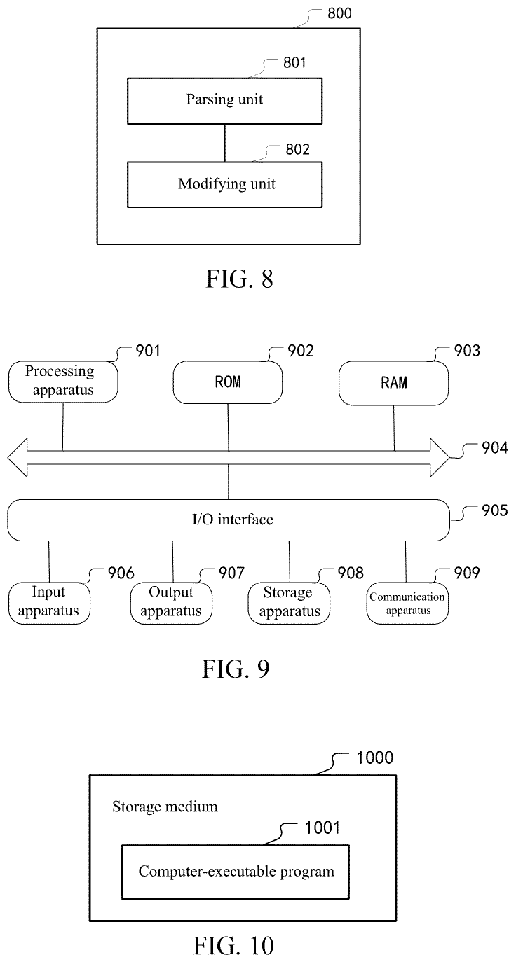

FIG. 8 shows a schematic block diagram of an apparatus of modifying data of a software object according to embodiments of the present disclosure. The apparatus is used for executing the method as shown in FIG. 2. As shown in FIG. 8, the apparatus 800 includes:

a parsing unit 801 configured to receive a target instruction for modifying a target object, and parse the target instruction to determine therefrom at least an operation type of the target instruction and an access path from the target object to target data included in the target object; and

a modifying unit 802 configured to search the target data from the target object according to the access path, and if the search is successful, modify the target data at least according to the operation type.

Embodiments of the present disclosure also provide an electronic device, including a memory and a processor, where an executable code is stored in the memory, and the executable code, when executed by the processor, implements the method according to the present disclosure, for example, as shown in FIG. 2.

Next, reference can also be made to FIG. 9, which shows a structural schematic diagram of an electronic device 800 suitable for implementing embodiments of the present application. The electronic device 900 shown in FIG. 9 is just an example, and should not bring any limitation to the functions and application scope of the embodiments of the present application.

As shown in FIG. 9, the electronic device 900 may include a processing apparatus (for example, a central processing unit, a graphics processor, etc.) 901. The processing apparatus 901 may be a general processor, a digital signal processor (DSP), a microprocessor or a microcontroller, and may further include an application specific integrated circuit (ASIC), a field-programmable gate array (FPGA) or other programmable logic devices, discrete gates or transistor logic devices, and discrete hardware components, which can perform various appropriate actions and processes according to programs stored in read-only memory (ROM) 902 or programs loaded into random access memory (RAM) 903 from the storage apparatus 908. In the RAM 903, various programs and data required for operations of the electronic device 900 are also stored. The processing apparatus 901, the ROM 902 and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touch pad, a keyboard, a mouse, etc.; an output apparatus 907 including, for example, a liquid crystal display (LCD), a speaker, a vibrator, etc.; a storage apparatus 908 including, for example, a magnetic tape, a hard disk, etc.; and a communication apparatus 909. The communication apparatus 909 may allow the electronic device 900 to perform wireless or wired communication with other devices to exchange data. While the electronic device 900 with various apparatuses is shown in the FIG. 9, it should be understood that it is not required to implement or have all the apparatuses shown. More or fewer apparatuses may alternatively be implemented or provided. Each block shown in FIG. 9 may represent one apparatus or multiple apparatuses as required.

In particular, according to the embodiments of the present application, processes described above with reference to the flowchart may be implemented as a computer software program. For example, embodiments of the present application include a computer program product, which includes a computer program carried on a computer-readable medium, the computer program including program codes for performing the method shown in the flowchart. In such an embodiment, the computer program may be downloaded and installed from a network through the communication apparatus 909, or installed from the storage apparatus 908, or installed from the ROM 902. The computer program, when executed by the processing apparatus 901, implements the above functions defined in the method for modifying data of the software object provided by the embodiment of the present application.

Embodiments of the present disclosure also provide a computer-readable storage medium having a computer program stored thereon, which, when executed in a computer, causes the computer to execute the method for modifying data of the software object as shown in FIG. 2 provided by the embodiments of the present application. FIG. 10 is a schematic diagram of a storage medium for implementing embodiments of the present application. For example, as shown in FIG. 10, the storage medium 1000 may be a non-transitory computer-readable storage medium for storing a non-transitory computer-executable instruction 1001. The non-transitory computer executable instruction 1001, when executed by a processor, may implement the method of modifying the data of the software object provided by the embodiments of the present application. For example, the non-transitory computer executable instruction 1001, when executed by a processor, may execute one or more steps of the method of modifying the data of the software object provided by the embodiments of the present application. For example, the storage medium 1000 may be applied to the above-mentioned electronic device. For example, the storage medium 1000 may include a memory in an electronic device. The description of the storage medium 1000 may refer to the description of the memory in the embodiments of the electronic device, which is omitted here. The specific functions and technical effects of the storage medium 1000 may refer to the description of the method for modifying data of the software object provided by the embodiments of the present application, which is also omitted here.

It should be noted that the computer-readable medium described in the disclosed embodiments can be a computer-readable signal medium, a computer-readable storage medium, or any combination of the two. Computer readable storage media can be, for example but not limited to, systems, devices, or elements of electricity, magnetism, light, electromagnetism, infrared, or semiconductors, or any combination thereof. More specific examples of computer-readable storage media may include, but are not limited to, electrical connections with one or more wires, memory cards for smartphones, storage components for tablets, portable computer disks, hard drives for personal computers, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof. In the disclosed embodiments, the computer-readable storage medium may be any tangible medium containing or storing a program that can be used by or in combination with an instruction execution system, apparatus, or device. In the disclosed embodiments, the computer-readable signal medium may include data signals propagated in the baseband or as part of a carrier wave, carrying computer-readable program code. This propagated data signal can take various forms, including but not limited to electromagnetic signals, optical signals, or any suitable combination thereof. Computer readable signal media can also be any computer-readable medium other than computer-readable storage media, which can send, propagate, or transmit programs for use by or in combination with instruction execution systems, devices, or equipment. The program code contained on a computer-readable medium can be transmitted using any suitable medium, including but not limited to: wires, optical cables, RF (Radio Frequency), etc., or any suitable combination of the above.

The computer-readable medium mentioned above may be included in the electronic device mentioned above; It can also exist independently without being assembled into the electronic device. The above-mentioned computer-readable medium carries one or more programs, which, when executed by the server, cause the electronic device to implement the method of modifying data of a software object provided in the embodiments of the present application.

The computer program code for performing the operations of the disclosed embodiments may be written in one or more programming languages or combinations thereof, including object-oriented programming languages such as Java, Smalltalk, C++, as well as conventional procedural programming languages such as “C” language or similar programming languages. Program code can be executed entirely on the user's computer, partially on the user's computer, as a standalone software package, partially on the user's computer, partially on a remote computer, or entirely on a remote computer or server. In cases involving remote computers, the remote computer can be connected to the user's computer through any type of network, including a local area network (LAN) or a wide area network (WAN), or can be connected to an external computer (such as using an internet service provider to connect via the internet).

The flowchart and block diagram in the accompanying drawings illustrate the possible implementation architectures, functions, and operations of the system, method, and computer program product according to various embodiments of the present disclosure. In this regard, each box in a flowchart or block diagram can represent a module, program segment, or part of code that contains one or more executable instructions for implementing specified logical functions. It should also be noted that in some alternative implementations, the functions marked in the boxes may occur in a different order than those marked in the figures. For example, two consecutive boxes can actually be executed in parallel, and sometimes they can also be executed in reverse order, depending on the functions involved. It should also be noted that each box in the block diagram and/or flowchart, as well as combinations of boxes in the block diagram and/or flowchart, can be implemented using dedicated hardware-based systems that perform specified functions or operations, or can be implemented using a combination of dedicated hardware and computer instructions. The units described herein can be implemented through software or hardware. In some cases, the name of a unit does not constitute a limitation on the unit itself. The functions described above in this article can be at least partially executed by one or more hardware logic components. For example, non-limiting exemplary types of hardware logic components that can be used include: Field Programmable Gate Arrays (FPGAs), Application Specific Integrated Circuits (ASICs), Application Specific Standard Products (ASSPs), System on Chip (SOC), Complex Programmable Logic Devices (CPLDs), and so on.

The various embodiments herein are described in a progressive manner, and the same and similar parts between each embodiment can be referred to each other. Each embodiment focuses on the differences from other embodiments. Especially for storage media and computing device embodiments, due to their basic similarity to method embodiments, the description is relatively simple. For relevant information, please refer to the explanations of method embodiments.

The above description is only a preferred embodiment of the present disclosure and an explanation of the technical principles applied. Technicians in this field should understand that the scope of the present disclosure is not limited to technical solutions formed by specific combinations of the above technical features, and should also cover other technical solutions formed by arbitrary combinations of the above technical features or their equivalent features without departing from the above disclosed concept. For example, a technical solution formed by replacing the above features with (but not limited to) technical features with similar functions disclosed herein. In addition, although the operations are depicted in a specific order, this should not be understood as requiring these operations to be executed in the specific order shown or in a sequential order. Under certain circumstances, multitasking and parallel processing may be advantageous. Similarly, although several specific implementation details are included in the above discussion, they should not be interpreted as limiting the scope of the present disclosure. Certain features described in the context of individual embodiments can also be combined and implemented in a single embodiment. On the contrary, various features described in the context of a single embodiment can also be implemented individually or in any suitable sub combination in multiple embodiments.

The specific implementation methods described above provide further detailed explanations of the objectives, technical solutions, and beneficial effects of the embodiments of the present invention. Although the subject matter has been described using language specific to structural features and/or method logic actions, it should be understood that the subject matter defined in the appended claims is not necessarily limited to the specific features or actions described above. On the contrary, the specific features and actions described above are merely exemplary forms of implementing the claims. It should be understood that the above description is only a specific embodiment of the present invention and is not intended to limit the scope of protection of the present invention. Any modifications, equivalent substitutions, improvements, etc. made on the basis of the technical solution of the present invention should be included in the scope of protection of the present invention.

1. A method of modifying data of a software object, comprising:
receiving a target instruction for modifying a target object, and parsing the target instruction to determine therefrom at least an operation type of the target instruction and an access path from the target object to target data comprised in the target object; and
searching the target data from the target object according to the access path, and if the search is successful, modifying the target data at least according to the operation type.

2. The method of claim 1, wherein the access path comprises a plurality of fields in sequence, an initial field in the plurality of fields corresponds to the target object, a last field in the plurality of fields corresponds to the target data, and remaining fields in the plurality of fields correspond to intermediate objects between the target object to the target data, the intermediate objects comprise a single object or an array object, wherein a post field of a corresponding field of any array object corresponds to an array member of the array object.

3. The method of claim 2, wherein the searching the target data from the target object according to the access path comprises:
sequentially parsing the plurality of fields from the access path, wherein for each field before the last field, if a field corresponds to a single object, the single object corresponding to the field is obtained by reflection, and an attribute corresponding to a post field of the field is searched from attributes comprised in the single object corresponding to the field; if a field corresponds to an array object, the array member corresponding to the post field of the field is obtained by reflection according to the field and a subscript of the post field of the field, and an attribute corresponding to the post field of the field is searched from attributes comprised in the array member.

4. The method of claim 1, wherein the operation type comprises a replace operation;
the parsing the target instruction to determine therefrom at least an operation type of the target instruction and an access path from the target object to target data comprised in the target object comprises: parsing the target instruction to determine therefrom the operation type of the target instruction, the access path from the target object to target data in the target object, and a target value; and
the modifying the target data at least according to the operation type comprises: changing a value of the target data according to the target value in response to the operation type being the replace operation.

5. The method of claim 4, wherein the changing the value of the target data according to the target value comprises:
if a data type of the target data is a basic type, converting the data type of the target value into the basic type, and changing the value of the target data according to the converted target value; and
if the data type of the target data is an object type, deserializing according to the target value to obtain an instance of the object type, and endowing the instance to the target data.

6. The method of claim 1, wherein the operation type comprises an add operation;
the parsing the target instruction to determine therefrom at least the operation type of the target instruction and the access path from the target object to target data comprised in the target object comprises: parsing the target instruction to determine therefrom the operation type of the target instruction, the access path from the target object to target data in the target object, and a target value; and
the modifying the target data at least according to the operation type comprises: adding array members or attributes comprised in the target data according to the target value in response to the operation type being the add operation.

7. The method of claim 1, wherein the operation type comprises a remove operation;
the modifying the target data at least according to the operation type comprises: setting the value of the target data as a default value in response to the operation type being the remove operation.

8. The method of claim 1, wherein the operation type comprises a reorder operation;
the parsing the target instruction to determine therefrom at least the operation type of the target instruction and the access path from the target object to target data comprised in the target object comprises: parsing the target instruction to determine therefrom the operation type of the target instruction, the access path from the target object to target data in the target object, and a target value; and
the modifying the target data at least according to the operation type comprises: reordering array members comprised in the target data according to the target value in response to the operation type being the reorder operation.

9. The method of claim 1, wherein the operation type comprises a nested operation;
the parsing the target instruction to determine therefrom at least the operation type of the target instruction and the access path from the target object to target data comprised in the target object comprises: parsing the target instruction to determine therefrom the operation type of the target instruction, the access path from the target object to target data in the target object, and a target value; and
wherein if the operation type is the nested operation, the target value comprises one or more sub-instructions, and an operation type of each sub-instruction comprises one selected from a group of an add operation, a remove operation, a replace operation, a reorder operation and a nested operation.

10. The method of claim 1, further comprising:
if the search is unsuccessful, abandoning a modification of the target data.

11. The method of claim 1, further comprising:
if the search is successful, storing the access path and the modified target data in a predetermined cache in an associated manner, wherein,
if the data type of the target data is an object, storing the access path, a parent object of the target data and the modified target data in the cache in an associated manner; and
if the data type of the target data is a basic type, storing the access path, the modified target data and a class name to which the target data belongs in the cache in an associated manner.

12. The method of claim 1, wherein the target object is a pre-built global singleton object.

13. An electronic device comprising a non-transitory memory and a processor, wherein executable codes are stored in the non-transitory memory, and the executable codes, when executed by the processor, cause the processor to:
receive a target instruction for modifying a target object, and parse the target instruction to determine therefrom at least an operation type of the target instruction and an access path from the target object to target data comprised in the target object; and
search the target data from the target object according to the access path, and if the search is successful, modify the target data at least according to the operation type.

14. The electronic device of claim 13, wherein the access path comprises a plurality of fields in sequence, an initial field in the plurality of fields corresponds to the target object, a last field in the plurality of fields corresponds to the target data, and remaining fields in the plurality of fields correspond to intermediate objects between the target object to the target data, the intermediate objects comprise a single object or an array object, wherein a post field of a corresponding field of any array object corresponds to an array member of the array object.

15. The electronic device of claim 14, wherein the searching the target data from the target object according to the access path comprises:
sequentially parsing the plurality of fields from the access path, wherein for each field before the last field, if a field corresponds to a single object, the single object corresponding to the field is obtained by reflection, and an attribute corresponding to a post field of the field is searched from attributes comprised in the single object corresponding to the field; if a field corresponds to an array object, the array member corresponding to the post field of the field is obtained by reflection according to the field and a subscript of the post field of the field, and an attribute corresponding to the post field of the field is searched from attributes comprised in the array member.

16. The electronic device of claim 13, wherein the operation type comprises a replace operation;
the parsing the target instruction to determine therefrom at least an operation type of the target instruction and an access path from the target object to target data comprised in the target object comprises: parsing the target instruction to determine therefrom the operation type of the target instruction, the access path from the target object to target data in the target object, and a target value; and
the modifying the target data at least according to the operation type comprises: changing a value of the target data according to the target value in response to the operation type being the replace operation.

17. The electronic device of claim 16, wherein the changing the value of the target data according to the target value comprises:
if a data type of the target data is a basic type, converting the data type of the target value into the basic type, and changing the value of the target data according to the converted target value; and
if the data type of the target data is an object type, deserializing according to the target value to obtain an instance of the object type, and endowing the instance to the target data.

18. The electronic device of claim 13, wherein the executable codes further cause the processor to:
if the search is successful, store the access path and the modified target data in a predetermined cache in an associated manner, wherein,
if the data type of the target data is an object, store the access path, a parent object of the target data and the modified target data in the cache in an associated manner; and
if the data type of the target data is a basic type, store the access path, the modified target data and a class name to which the target data belongs in the cache in an associated manner.

19. A non-transitory computer-readable storage medium storing instructions that cause a processor to:
receive a target instruction for modifying a target object, and parse the target instruction to determine therefrom at least an operation type of the target instruction and an access path from the target object to target data comprised in the target object; and
search the target data from the target object according to the access path, and if the search is successful, modify the target data at least according to the operation type.

20. The non-transitory computer-readable storage medium of claim 19, wherein the access path comprises a plurality of fields in sequence, an initial field in the plurality of fields corresponds to the target object, a last field in the plurality of fields corresponds to the target data, and remaining fields in the plurality of fields correspond to intermediate objects between the target object to the target data, the intermediate objects comprise a single object or an array object, wherein a post field of a corresponding field of any array object corresponds to an array member of the array object.
